(19) United States
(12) Patent Application Publication
(10) Pub. No.: US 2020/0109829 A1
(43) Pub. Date: Apr. 9, 2020

(54) LIGHTING FEATURES INCORPORATED INTO SPORTING GOODS, TOYS, HOUSEHOLD AND AUTOMOTIVE ITEMS

(71) Applicant: Robert Malone, Garland, TX (US)

(72) Inventor: Robert Malone, Garland, TX (US)

(21) Appl. No.: 16/704,887

(22) Filed: Dec. 5, 2019

Related U.S. Application Data
(63) Continuation-in-part of application No. 15/614,517, filed on Jun. 5, 2017, now abandoned.
(60) Provisional application No. 62/345,614, filed on Jun. 3, 2016.
(60) Provisional application No. 62/345,617, filed on Jun. 3, 2016.

(51) Int. Cl. F21S 4/26; F21S 9/03; F21V 31/00; F21V 33/00

(52) U.S. Cl. CPC F21S 4/26; F21S 9/035; F21Y 2115/10; F21V 33/008; B63B 35/74; F21V 31/005

(57) ABSTRACT

Lighting effects can be added to various items such as sporting goods and toys, such as cheer poms, cheer megaphones, pool and beach floats, rafts, stuffed toys, vases and hanging planters, flower/bouquet wraps and seating, such as automotive seating. The lights may be LED lights that provide a relatively bright light output with respect to the power consumed. The LED lights may be selectable between various colors and may flash, be solid, or light in a pattern, as is known in the art. One or more solar charging units may be used to charge a power source, such as a battery pack, in the item. In other embodiments, a rechargeable battery pack may be charged by plugging in the device or having the device in proximity to a proximity charger, for example. Alternatively, a standard replaceable battery pack may be used in the device.

### CROSS-REFERENCE TO RELATED APPLICATIONS

This application is a continuation-in-part of U.S. patent application Ser. No. 15/614,517, filed Jun. 5, 2017, which claims the benefit of priority to U.S. provisional patent applications Nos. 62/234,614, and 62/234,617, each filed Jun. 3, 2016, the contents of which are herein incorporated by reference.

### BACKGROUND OF THE INVENTION

The present invention relates to lighted devices and, more particularly, to various items utilizing lighting, such as light emitting diode (LED) lighting to add display features to sporting goods, such as cheer poms, megaphones, pool and beach floats, river rafts, stuffed toys, planters and vases, flower wraps, seating and wall glass and/or stone tiles.

Many items are available to consumers. While LED lights are available in various forms, many items on the market have not combined the lighting features available by these various forms of LED lighting with various products on the market.

Cheer poms and megaphones are used in stadium stands and by cheerleaders and drill teams. These items have progressed from tissue poms, to plastic poms, to metallic poms. No such product exists, however, that provided lighting features to poms or other cheer products. Similarly, other play items, such as children's stuffed animals, lack lighting features that are integral and convenient, while also providing a desirable lighting feature to the toy.

Pool and swimming accessories, such as floats, tubes, boards and the like, are used in pools and on beaches. People sometimes use pools or visit beaches after dark, but users have to provide their own lighting to know who or where the float may be located. Similarly, when rafting, along a river for example, one may encounter dark caves or passages. Rafts are typically not provided with integral and convenient lighting features.

Decor items are used around the home. These items can include flower vases and hanging pots for flowers, plants and the like. When not placed in a vase or pot, or when bundled for sale, flowers are typically just wrapped in plastic and/or tissue wrapping. Like the above items, these items do not include lighting features that can add to the overall decor provided by the items.

In vehicles, people have added lighting to the underside of cars for a specific lighting effect. However, there is limited use of lighting features inside the vehicle. Car seats are often plain or may be covered with various prints or patterns. However, no lighting features have been incorporated into the car seats themselves.

As can be seen, there is a need for the addition of lighting, such as LED lighting, to various items that are currently used without such lighting features.

### BRIEF DESCRIPTION OF THE DRAWINGS

FIG. 1 is a perspective view of a cheer porn having lights according to an exemplary embodiment of the present invention;

FIG. 2 is a perspective view of a cheer porn having lights according to an exemplary embodiment of the present invention;

FIG. 3 is a side view of footwear having a mini cheer porn having lights according to an exemplary embodiment of the present invention;

FIG. 4 is a perspective view of a tube float having lights according to an exemplary embodiment of the present invention;

FIG. 5 is a side view of a lounge float having lights according to an exemplary embodiment of the present invention;

FIG. 6 is a front view of a stuffed toy having lights according to an exemplary embodiment of the present invention;

FIG. 7 is a partially cut away partial front view of the stuffed toy of FIG. 6;

FIG. 8 is a side view of the stuffed toy of FIG. 6;

FIG. 9 is a cut-away side view of a vase having a lighting feature according to an exemplary embodiment of the present invention;

FIG. 10 is a partially cut-away side view of a hanging planter having a lighting feature according to an exemplary embodiment of the present invention;

FIG. 11 is a side view of a flower/bouquet wrap having a lighting feature according to an exemplary embodiment of the present invention;

FIG. 12 is an exploded perspective view of the flower/bouquet warp of FIG. 11;

FIG. 13 is a perspective view of the light wire used in the flower/bouquet wrap of FIG. 11;

FIG. 14 is a partially cut-away side view of a seat having lighting features according to an exemplary embodiment of the present invention;

FIG. 15 is a front view of a lighted wall tile or stone structure according to an exemplary embodiment of the present invention; and

FIG. 16 is a schematic view of connectivity for the lighted wall tile or stone structure of FIG. 15.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides lighting effects on various items. These items can include sporting goods and toys, such as cheer poms, cheer megaphones, pool and beach floats, rafts, stuffed toys, vases and hanging planters, flower/bouquet wraps and seating, such as automotive seating, and the like. The lights may be, for example, LED lights that provide a relatively bright light output with respect to the power consumed. In some embodiments, the LED lights may be selectable between various colors and may flash, be solid, or light in a pattern, as is known in the art. In some embodiments, one or more solar charging units may be used to charge a power source, such as a battery pack, in the item. In other embodiments, a rechargeable battery pack may be charged by plugging in the device or having the device in proximity to a proximity charger, for example. In other embodiments, a standard replaceable battery pack may be used in the device.

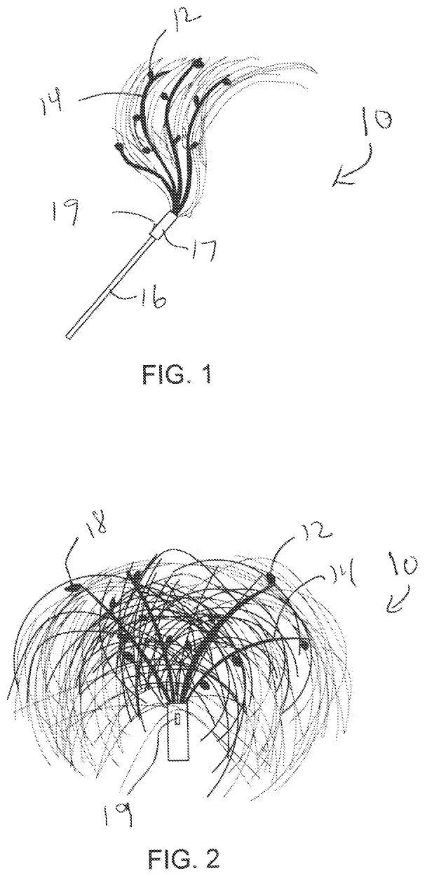

Referring to FIGS. 1 and 2, a cheer porn 10 can include lights 12 disposed along a string-like member 14. A plurality of these string-like members 14 can extend from the handle 16 of the cheer porn 10. A plurality of lights 12, such as LED lights, may be disposed along each string. The strings may be colored to match the colors of the cheer poms, for example, or may be colored in different colors. A power source 17 may be disposed in or adjacent to a handle 16 of the porn 10. The power source 17, as described above, may be a rechargeable battery, a replaceable battery, or the like. In some embodiments, one or more of the string-like members 14 may include, for example, at the end thereof, a solar cell 18 to help maintain charge in the power source. An on and off switch 19 may be disposed at or near the power source to turn the lights on and off, as desired.

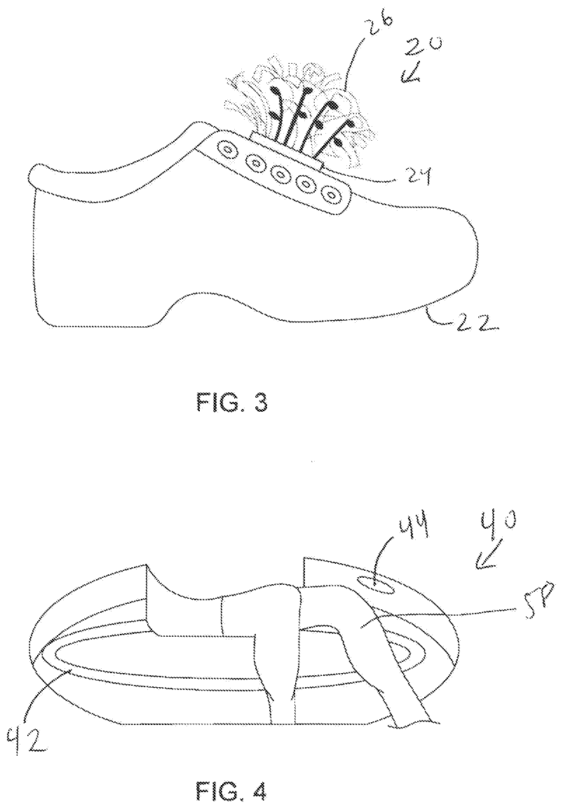

Referring now to FIG. 3, a miniature cheer porn 20, similar to those described above, may be used to attach to various articles of clothing, such as footwear 22 as shown in the Figure. Of course, the miniature cheer porn 20 may attach to any article of clothing or accessory, as may be desired by the user. The miniature cheer porn 20 may include the various features described above with respect to FIGS. 1 and 2, including a power source 24, an on/off switch, one or more solar cells 26, and the like.

The cheer poms may not only be useful for adding a light display to cheers and the like, but may also be useful as a safety device. The cheer poms, with their light strings, may help identify people in dark parking lots or if the lights go out in a stadium or gym.

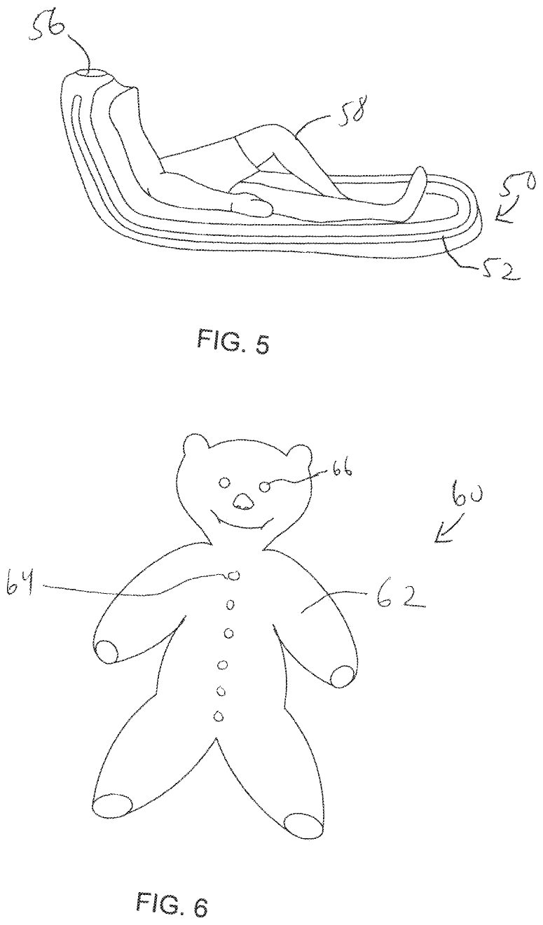

Referring to FIGS. 4 and 5, a pool or beach accessory or float in which a user 58 (only a portion of the user is shown) may rest, such as a tube float 40 or a lounge float 50, for example, may include an LED light tube 42, 52 disposed within the float or attached to an exterior portion thereof. In some embodiments, the LED light tube 42, 52 may be disposed inside the float 40, 50, adjacent to an exterior wall thereof. The LED light tube 42, 52 may be disposed about the entire float or in a particular area. In some embodiments, the light tube may spell a word, show a logo, or the like. A port 44, such as a reach-in port, may be disposed to allow a user's hand to reach in to access the battery, on/off switch, and the like. One or more solar 56 cells may be used to maintain charge in the battery. The solar cells 56 may be disposed on or made integral to the float itself. Other float styles, such as rafts, boards, or the like, may be included within the scope of the present invention. In this embodiment, as well in other embodiments, fiber optics may be used to spread the illumination from the LED lights, either in a string-like illuminated member, or to points at terminus of the fiber optics, for example.

The LED light tube may be attached to safety-type floats as well. For example, a throw ring on a boat may have the light tube disposed therein, similar to that described above, so that when thrown, the lights may help both the rescuer and the person being rescued keep track of the flotation device. In this embodiment, the on/off switch may be replaced with an automatic switch that may activate upon striking the water surface or upon getting wet, for example.

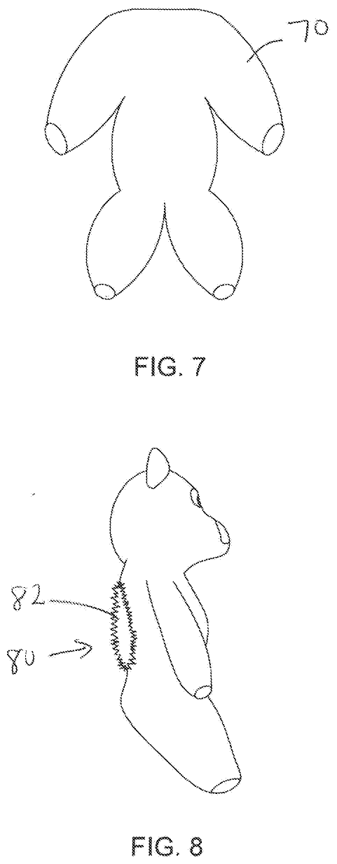

Referring to FIGS. 6 through 8, a stuffed toy, such as a teddy bear 60, can include various lights 64 disposed therein. The lights 64 may be solid or flashing from under an outer covering of the stuffed toy. The outer covering may take the appearance of the stuffed animal, for example, and may be removable for the purpose of cleaning. A protective webbing 70 can be used to cover over the internal wiring the LED lights, to protect the wiring and the lights. The protective webbing 70 may be attached to an inside of the outer covering 62 of the teddy bear 60. The core of the stuffed toy can be made of typical stuffing material. In some embodiments, the eyes may be made of lenses to provide access to solar cells 66 that may be used to charge the power source of the stuffed toy. As described above, the power source 80 may be a rechargeable battery, a replaceable battery or the like. As discussed above, a charging port may be provided to charge the rechargeable batteries, especially when a solar cell is not provided or when the solar cell is insufficient to charge the batteries. The power source may be disposed inside the stuffed toy and, in some embodiments, an access port 82 may be provided to permit access to the inside of the toy for servicing.

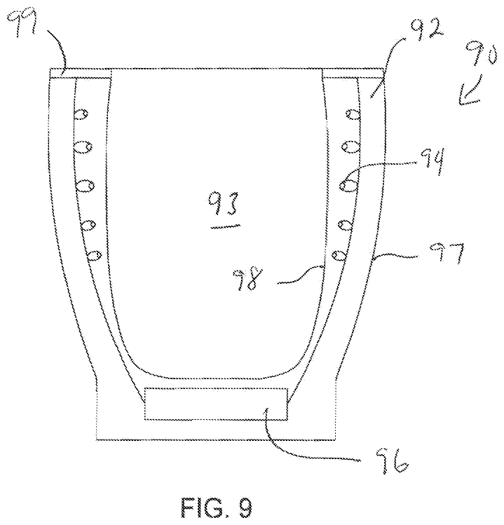

Referring now to FIG. 9, a vase or planter 90 may include an interior chamber 92 formed between the central open region 93 (for holding the flowers or plants) and the outside surface of the vase or planter. The central open region 93 may be water tight, or may include a drain to the exterior. The interior chamber 92, containing the lights 94, may be formed watertight to prevent damage to the lights and/or battery pack 96. Wire lights, such as wire LED lights, may be disposed in various configurations within this inner chamber. The exterior 97 of the planter or vase may be translucent to permit the light to shine out of the vase or planter. In some embodiments, the inside wall 98 of the planter or vase may be translucent to allow the light to shine to the central open region. This embodiment may be useful when used as a vase and filled with water, as the water can appear to be illuminated by the lights.

A battery pack 96 may be disposed within the vase or planter, for example, at a bottom region thereof, as shown in the Figure. In some embodiments, additional weight may be disposed in the base to help stabilize the vase or planter. Of course, the battery pack may appear in various locations in and one the vase or planter. A portion of the exterior of the vase or planter, such as an upper portion, may be formed from solar cells 99 to help charge the battery pack. In some embodiments, a power port may be present to deliver a charge to the battery pack if needed when power is plugged into the power port. In some embodiments, the battery pack may be replaceable batteries. An on/off switch (not shown) may be disposed on the vase or planter to turn the lights on and off, as desired.

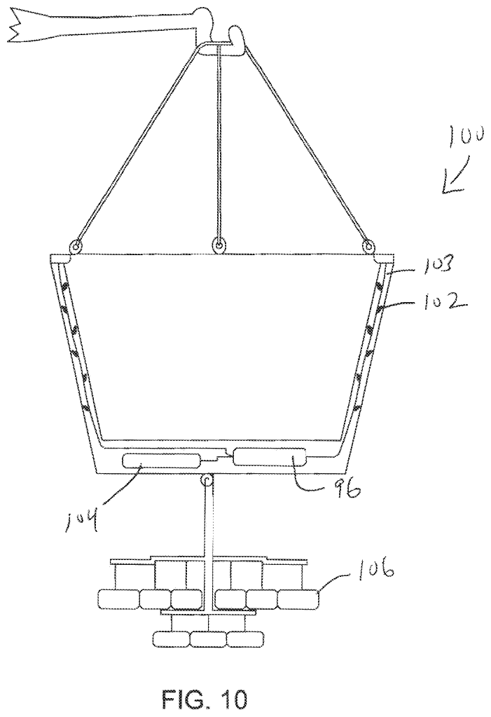

Referring now to FIG. 10, a planter 100, similar to that described above with respect to FIG. 9, may be a hanging planter having the lights 102 disposed in an interior chamber 103 formed therein. In some embodiments, a wind chime sound box 104 may be included in the planter. This box may be activated by a motion detector, or by a wind detector, for example. The box may make a sound similar to a wind chime. In an alternative embodiment, an actual wind chime 106 may be hung from a bottom portion of the planter.

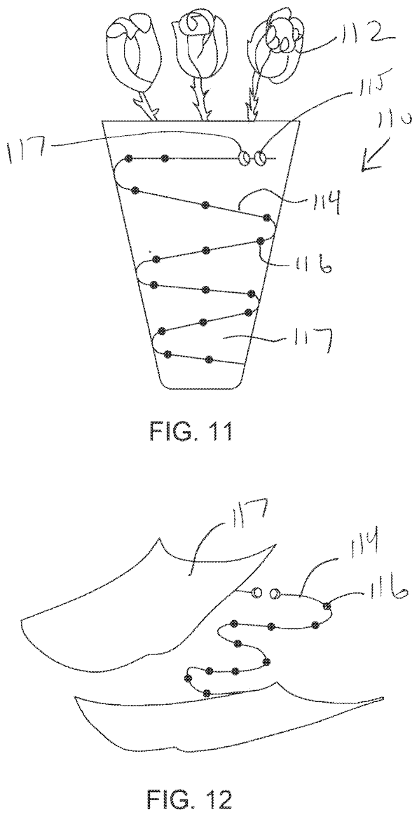

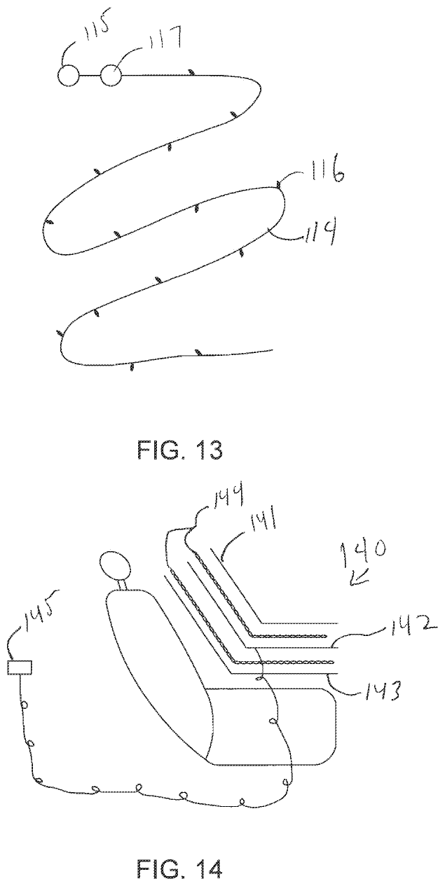

Referring to FIGS. 11 through 13, a wrap 110 for plants or flowers 112 may include a light string 114, such as an LED light string, a wrapping material 117, and a power source for the lights 116. The wrapping material may be any conventional material and may be transparent, translucent or solid. The wrapping material 117 may be placed around, for example, flower stems, and the light string 114 may be used to wrap the stems and wrapping material in a bouquet. The light string 114 may include a rechargeable battery 115 or a replaceable battery. A solar cell 117 may be used to recharge the rechargeable batteries. In some embodiments, a power port (not shown) may be provided to charge the batteries. Clips may be provided on ends of the light string to secure each end to the wrapping or the stems, thereby preventing the unraveling of the light string. In some embodiments, the light string may be a flexible material that can retain its shape, thereby allowing wrapping and securing of the stems without the need to clip the ends.

Referring to FIG. 14, seat covers 140, such as those for cars, trains, airplanes, or the like, may include a top cover 141 with a wire light 142, such as an LED wire light, disposed under the top cover 141. A cloth backing 143 may be provided to sandwich the wire light with the top cover. A soft fiber material 144 may be used on either side of the wire light to help cushion the light and provide comfort to the user. In some embodiments, the seating may be gel seating, similar to the gel support insoles in shoes, for example, where LED lighting may be applied on the material itself or added together inside the material. The gel seating may be used by itself of with conventional seat covering materials. In some embodiments, an air control may be used to inflate and deflate seating material, such as the gel seating material or any other type of sealed seating material.

The wire light may be connected to a power source 145, such as a solar power source, a battery pack, or may be hard-wired to the vehicle's power supply. The seat covers 140 may be an add on to a car seat or may be designed in the originally installed car seats. The seat covers 140 may be used not only for car seats, but for video gaming seats, for playroom chair, movie theater seats, cars, trucks all on-road and off-road automobiles, bikes, riding toys, saddles, motorcycles, two and three wheelers, jet skis, snowmobiles, planes, airliners, helicopters, space travel crafts. and the like. The intensity of the lighting may be configured to match the desired use. For example, a top cover may only permit a certain amount of light therethrough, providing filtered lighting. In other embodiments, the intensity of the light may be controlled by applying a certain amount of power from the power source.

Seat lighting may include safety features. For example, the seat lighting may be configured to blink on and off when exiting the vehicle and/or when the alarm is turned on or off. If the alarm sounds, the seat lighting may illuminate to help deter theft.

Seat lighting may not only include seat covers, but such seat lighting may be made integral with the seats at the time the seat is manufactured. Such lighting could further include seat lighting on other such seats, such as patio chairs, beach chairs and other seating structures as may be understood in the art.

In some embodiments, features such a light dimming may be used to adjust the brightness of the light. Moreover, the lighting may be configured in various patterns of designs, such as a team or company logo, emblems, lettering, initials, or the like. In some embodiments, a microphone may be used to detect music, voice, sounds or the like where the lighting may be reactive to music that is played.

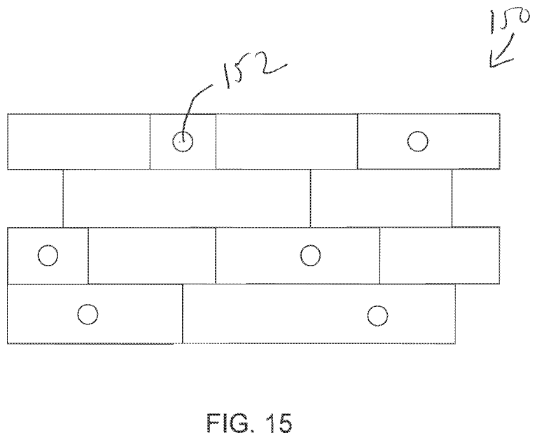

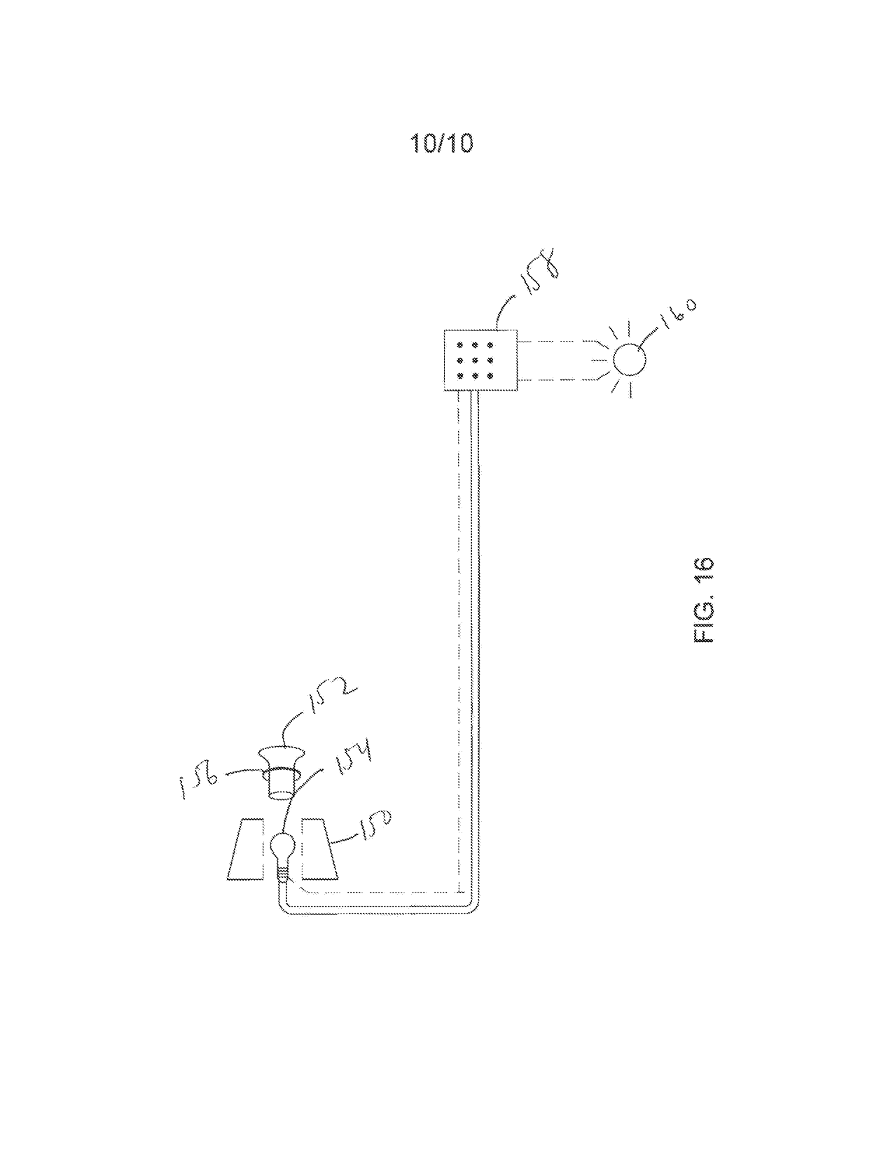

Referring to FIGS. 15 and 16, glass, stone or tile 150 may include one or more bulb covers 152 that provide access inside the tile 150. The bulb cover 152 may house a LED bulb 154 therein. In some embodiments, an o-ring 156 may provide water-tightness for the bulb cover 152. The LED bulbs 154 may be wired to a controller 158 that can provide various light functions, including different colors, brightness, flashing, or the like. An optional dimmer 160 may be used to control the brightness of the LED bulbs 154. Glass tiles may be custom sized, etched or include a back mirror, for example.

It should be understood, of course, that the foregoing relates to exemplary embodiments of the invention and that modifications may be made without departing from the spirit and scope of the invention as set forth in the following claims.

What is claimed is:

1. A wall covering comprising:
a plurality of openings formed in the wall covering;
a bulb covering fitting into each of the openings;
an LED bulb disposed in each of the plurality of openings; and
a controller controlling power being sent to each of the bulbs.

2. The wall covering of claim 1, wherein the wall covering is stone tile.

3. The wall covering of claim 1, wherein the wall covering is a glass tile.

4. The wall covering of claim 1, further comprising an o-ring about the bulb covering to provide a seal about the plurality of openings.

5. The wall covering of claim 1, further comprising a dimmer control.

6. A flotation device, comprising:
an LED light string disposed on the flotation device;
a power supply providing power to the LED light string; and
an on-off switch for connecting and disconnecting the LED light string from the power supply.

7. The flotation device of claim 6, further comprising a solar panel for charging the power supply.

8. The flotation device of claim 7, wherein the flotation device is a pool float.

9. The flotation device of claim 7, wherein the solar panel is integral with an outer surface of a flotation device body.

10. The flotation device of claim 6, further comprising an access port to access an interior of the flotation device.

11. The flotation device of claim 10, wherein the power supply is housed inside the access port.

12. The flotation device of claim 7, wherein the light string is disposed inside a transparent region of a floatation device body.
